(19) United States
(12) Patent Application Publication
(10) Pub. No.: US 2026/0267820 A1
(43) Pub. Date: Sep. 10, 2026

(54) Interconnect Routing

(71) Applicant: Arm Limited, Cambridge (GB)

(72) Inventors: Dimitrios Kaseridis, Austin, TX (US); Mark David Werkheiser, Austin, TX (US); Jamshed Jalal, Austin, TX (US); Harrison MinHo Mccreary, Austin, TX (US); Rajesh Bhikhubhai Patel, Austin, TX (US); Anitha Kona, Austin, TX (US); Lauren Elise Guckert, Austin, TX (US)

(73) Assignee: Arm Limited, Cambridge (GB)

(21) Appl. No.: 19/086,279

(22) Filed: Mar. 21, 2025

(30) Foreign Application Priority Data
Mar. 5, 2025 (EP) 25300013.7

(51) Int. Cl. G06F 15/173; G06F 15/78

(52) U.S. Cl. CPC G06F 15/17312; G06F 15/7821

(57) ABSTRACT

An integrated-circuit apparatus comprises a 2D or 3D interconnect comprising a plurality of routers distributed along at least an X axis and a Y axis, wherein the 2D or 3D interconnect comprises at least a first layer of routers logically coupled as a polygonal mesh of routers. The interconnect further comprises a first storage or input-output node coupled to the interconnect along a Y-axis edge of the first layer, or a further layer, of routers of the interconnect; and a second storage or input-output node coupled to the interconnect along an X-axis edge of the first layer, or a further layer, of routers of the interconnect. At least a first router of the first layer of routers is configured to use X-Y routing when routing a flit originating from the first storage or input-output node and destined for a first target node coupled to the interconnect. At least the first router or a second router of the first layer of routers is configured to use Y-X routing when routing a flit originating from the second storage or input-output node and destined for the first target node or a second target node coupled to the interconnect.

### TECHNICAL FIELD

The present disclosure relates to routing flits within an integrated-circuit interconnect.

### BACKGROUND

Integrated-circuit data processing systems, such as a system-on-chip (SoC), can include multiple components coupled by an interconnect as nodes of a network. Such components can include processing devices, storage devices and input-output devices. Processing devices may include central processing units (CPUs), CPU clusters, graphics processing units (GPUs), GPU clusters and other accelerators. Storage and input-output devices may include memory, memory controllers, input-output interfaces, bridges, etc.

Such an interconnect may comprise a plurality of coupled routers, e.g. arranged as a rectangular mesh. The routers direct flits (i.e. packets) between the components of the network—i.e. from a source node to a target node.

It is desirable to route flits through an integrated-circuit interconnect in a way that avoids deadlock. Deadlock can arise when a closed loop forms in which every router along the loop is waiting to send a respective flit to a next router in the loop before it can itself receive a flit from a preceding router in the loop. Such a situation can be prevented from ever arising by controlling the outgoing direction or directions in which each router is allowed to send a flit. In the context of a polygonal (e.g. rectangular or L-shaped) mesh having an X-axis and a Y-axis, this may be done by implementing a turn-restriction routing scheme.

For example, in X-Y routing, a flit destined for a target node is first routed parallel to the X-axis until the flit is Y-axis aligned with the target node, and is then routed parallel to the Y-axis to reach the target node. By enforcing X-Y routing across the interconnect, it can be guaranteed that no deadlock routing loops can ever arise.

However, such an approach can be inefficient and lead to congestion within the interconnect.

### SUMMARY

Disclosed herein is an integrated-circuit apparatus comprising a 2D or 3D interconnect comprising a plurality of routers distributed along at least an X axis and a Y axis, wherein the 2D or 3D interconnect comprises at least a first layer of routers logically coupled as a polygonal mesh of routers. The interconnect further comprises a first storage or input-output node coupled to the interconnect along a Y-axis edge of the first layer, or a further layer, of routers of the interconnect; and a second storage or input-output node coupled to the interconnect along an X-axis edge of the first layer, or a further layer, of routers of the interconnect. At least a first router of the first layer of routers is configured to use X-Y routing when routing a flit originating from the first storage or input-output node and destined for a first target node coupled to the interconnect. At least the first router or a second router of the first layer of routers is configured to use Y-X routing when routing a flit originating from the second storage or input-output node and destined for the first target node or a second target node coupled to the interconnect.

Also disclosed is a method of routing a flit in an integrated-circuit apparatus, the integrated-circuit apparatus comprising: an interconnect comprising a plurality of routers, wherein the plurality of routers are logically coupled as a polygonal mesh of routers; a first storage or input-output node coupled to one or more of the routers along a Y-axis edge of the polygonal mesh of routers; and a second storage or input-output node coupled to one or more routers along an X-axis edge of the polygonal mesh of routers. The method comprises at least a first router of the plurality of routers using X-Y routing to route a flit originating from the first storage or input-output node and destined for a first target node coupled to the interconnect; and at least the first router or a second router of the plurality of routers using Y-X routing to route a flit originating from the second storage or input-output node and destined for the first target node or a second target node coupled to the interconnect.

Also disclosed herein is an integrated-circuit apparatus comprising an interconnect for routing flits. The interconnect comprises a plurality of routers. For at least one of routers, the router comprises a plurality of ports, each coupled to a further respective router of the plurality of routers. The router is configured to route a flit, originating from a source node coupled to the interconnect and destined for a target node coupled to the interconnect, according to a first turn-restriction routing scheme when the router is operating in a first mode for the source node and target node, and according to a second turn-restriction routing scheme, different from the first turn-restriction routing scheme, when the router is operating in a second mode for the source node and the target node. The router is configured to determine in which of the first and second modes to operate when routing the flit in dependence upon configuration data.

Also disclosed herein is a method of routing a flit, performed by a router of an interconnect of an integrated-circuit apparatus. The method comprises receiving a flit, originating from a source node and destined for a target node. Configuration data is accessed that indicates whether to route the flit according to a first turn-restriction routing scheme or according to a second turn-restriction routing scheme different from the first turn-restriction routing scheme. The configuration data is used to determine whether to route the flit according to the first turn-restriction routing scheme or according to the second turn-restriction routing scheme. The flit is routed according to the indicated turn-restriction routing scheme.

### BRIEF DESCRIPTION OF THE DRAWINGS

Certain embodiments of the disclosure will now be described, by way of example only, with reference to the accompanying drawings, in which:

FIG. 1 is a schematic diagram of part of an integrated-circuit data processing system embodying the present disclosure;

FIG. 2 is a schematic diagram of an interconnect that illustrates X-Y routing;

FIG. 3 is a schematic diagram of an interconnect that illustrates Y-X routing;

FIG. 4 is a schematic diagram of an interconnect exhibiting high congestion using Y-X routing;

FIG. 5 is a schematic diagram of an interconnect embodying the present disclosure exhibiting low congestion using X-Y routing;

FIG. 6 is a schematic diagram of an interconnect embodying the present disclosure; and

FIG. 7 is a flow chart of a method embodying the present disclosure.

### DETAILED DESCRIPTION

Some embodiments provide an integrated-circuit apparatus comprising a 2D or 3D interconnect comprising a plurality of routers distributed along at least an X axis and a Y axis (and optionally a Z axis), wherein the 2D or 3D interconnect comprises at least a first layer of routers logically coupled as a polygonal mesh of routers. The interconnect may comprise a first storage or input-output node coupled to the interconnect along a Y-axis edge of the first layer, or a further layer, of routers of the interconnect, and a second storage or input-output node coupled to the interconnect along an X-axis edge of the first layer, or a further layer, of routers of the interconnect.

At least a first router of the first layer of routers may be configured to use X-Y routing when routing a flit originating from the first storage or input-output node and destined for a first target node coupled to the interconnect; and at least the first router or a second router of the first layer of routers may be configured to use Y-X routing when routing a flit originating from the second storage or input-output node and destined for the first target node or a second target node coupled to the interconnect.

Such apparatus may help to avoid congestion along the Y-axis edge and along the X-axis edge through such use of X-Y routing and Y-X routing.

The IC apparatus may be a single IC chip or may comprise a plurality of IC chips or chiplets. The interconnect may be provided by a single chip or may be distributed across a plurality of chips or chiplets. The apparatus may comprise a plurality of nodes, which may be respective devices. A node may be a processor, a neural processor, an accelerator, an interface, a memory controller, a coherency cache, or a peripheral. Each node may be coupled to a respective port of a respective router. Each router may comprise one or more mesh ports and zero or more device ports.

The plurality of routers may be logically coupled as a polygonal mesh of routers having an X axis and a Y axis (and optionally a Z axis). Each router may have one or more X ports (east and/or west ports) and one or more Y ports (north and/or south ports). The interconnect may be two-dimensional (2D) and may have a single layer, or may be three-dimensional (3D) and may comprise a plurality of layers. In some embodiments, a layer may be or may comprise a set or routers logically arranged and coupled parallel to the X axis and/or parallel to the Y axis, e.g. being spaced at uniform intervals. The layer may be or comprise a rectangular (e.g. square) or L-shaped mesh of routers.

Each storage node may be a memory or a memory controller. Each input-output node may be a peripheral or an interface to an interconnect, bus, chip or chiplet (e.g. a PCIe bridge or a chip-to-chip gateway).

In some embodiments, the first router (and optionally each of one or more further routers) is configured to use Y-X routing when routing a flit originating from the second storage or input-output node and destined for the first or second target node.

Every router of the first layer on an X-Y path from the first storage or input-output node to the first target node may be configured to use X-Y routing when routing a flit originating from the first storage or input-output node to the first target node along the X-Y path, and every router of the first layer on a Y-X path from the first storage or input-output node to the first or second target node may be configured to use Y-X routing when routing a flit originating from the second storage or input-output node and destined for the first or second target node along the Y-X path.

In some embodiments, every router of the first layer of routers, or of the interconnect, may be configured to use X-Y routing if routing a flit originating from the first storage or input-output node, and to use Y-X routing if routing a flit originating from the second storage or input-output node. (However, some of these routers may not lie on an X-Y or Y-X path, and so may never in practice receive such flits.)

The IC apparatus may comprise a plurality of first storage or input-output nodes coupled to the interconnect along the aforesaid Y-axis edge; and a plurality of second storage or input-output nodes coupled to the interconnect along the aforesaid X-axis edge. At least the first router may be configured to use X-Y routing when routing a flit originating from any of the first storage or input-output nodes. At least the first or second router may be configured to use Y-X routing when routing a flit originating from any of the second storage or input-output nodes.

In some embodiments, at least the first router may be configured to use Y-X routing when routing a flit originating from the first target node and destined for the first storage or input-output node; and at least the first or second router may be configured to use X-Y routing when routing a flit originating from the first or second target node and destined for the second storage or input-output node.

In some embodiments, for every router of the first layer, or for every router of the interconnect, the router comprises a plurality of ports, each coupled to a further respective router of the plurality of routers, and the router is configured to route a flit, originating from a source node coupled to the interconnect and destined for a target node coupled to the interconnect, according to a first turn-restriction routing scheme when the router is operating in a first mode for the source node and the target node, and according to a second turn-restriction routing scheme, different from the first turn-restriction routing scheme, when the router is operating in a second mode for the source node and the target node. Each respective router may be configured to determine in which of the first and second modes to operate when routing the flit in dependence upon configuration data stored in a configuration memory of the integrated-circuit apparatus.

The IC apparatus may perform a method of routing a flit comprising at least a first router of the plurality of routers using X-Y routing to route a flit originating from the first storage or input-output node and destined for a first target node coupled to the interconnect; and at least the first router or a second router of the plurality of routers using Y-X routing to route a flit originating from the second storage or input-output node and destined for the first target node or a second target node coupled to the interconnect.

Each router may comprise a plurality of ports, each coupled to a further respective router of the plurality of routers.

The first and/or second router, and optionally all routers of the layer or interconnect, may be statically configured, or may be dynamically configurable, e.g. at boot time. Each router may be configured to route a flit according to a first turn-restriction routing scheme or according to a second turn-restriction routing scheme in dependence upon configuration data, which may be stored in a storage such as a memory of the apparatus. The configuration data may be rewritable.

Some embodiments provide an integrated-circuit (IC) apparatus comprising an interconnect for routing flits, wherein the interconnect comprises a plurality of routers, and wherein, for at least one of routers:
the router is configured to route a flit, originating from a source node coupled to the interconnect and destined for a target node coupled to the interconnect, according to a first turn-restriction routing scheme when the router is operating in a first mode for the source node and target node, and according to a second turn-restriction routing scheme, different from the first turn-restriction routing scheme, when the router is operating in a second mode for the source node and the target node; and
the router is configured to determine in which of the first and second modes to operate when routing the flit in dependence upon configuration data.

The first turn-restriction routing scheme may be X-Y routing, and the second turn-restriction routing scheme may be Y-X routing. If the interconnect is 3D and has a Z axis, such X-Y routing and Y-X routing may be performed within a layer of the mesh and may additionally encompass Z-axis routing (e.g. the X-Y routing may be X-Y-Z or Z-X-Y or X-Z-Y routing).

The integrated-circuit apparatus may comprise storage (e.g. a hardware register or a memory) configured to store the configuration data. The router may comprise circuitry for read the configuration data from the storage and for controlling operations of the router in dependence thereon. The storage may be writable by software executing on one or more processing devices of the integrated-circuit apparatus. The storage and/or configuration data may be specific to a respective router, or it may be in common for all or a subset of the plurality of routers. The storage may be writable at (and optionally only at) a boot time of the integrated-circuit apparatus. This may allow the configuration of the interconnect to be changed by firmware or other software executing on the apparatus. In particular, it may allow the determination of which routing scheme to use for a particular source node and target node to be changed after the apparatus has been deployed. This may be useful if a defect arises or is discovered in a particular IC apparatus, or for altering performance characteristics of the apparatus.

In some embodiments, a router may be configured to operate, over a period of time, in the first mode or second mode for all source node and target nodes, irrespective of the source and target node identities—i.e. when routing flits originating from any source node and destined for any target node. However, in other embodiments the router may be able to simultaneously operate in one mode for one source-target pair and a different mode for another source-target pair. The router may be configured, after receiving the flit, to:
determine an identity of the source node;
determine an identity of the target node; and
determine in which of the first and second modes to operate when routing the flit in further dependence upon the determined identities of the source node and target node.

The apparatus may comprise storage configured to store, for the router, separate respective configuration data for each of a plurality of combinations of source node and the target node.

In some embodiments, the ability to support multiple routing schemes could be confined to just one router, in other embodiments, every router of the plurality of routers (which may be every router of the interconnect) comprises a plurality of ports, each coupled to a further respective router of the plurality of routers, and is configured to route a flit, originating from a respective source node coupled to the interconnect and destined for a respective target node coupled to the interconnect, according to the first turn-restriction routing scheme when the router is operating in a first mode for the respective source node and respective target node, and according to the second turn-restriction routing scheme, different from the first turn-restriction routing scheme, when the router is operating in a second mode for the respective source node and respective target node. Every router may be configured to determine in which of the first and second modes to operate when routing the flit in dependence upon configuration data, which may be the same for every router or which may be specific to each respective router (and so may be different for different routers).

Any of the plurality of routers may perform a method of routing a flit, the method comprising:
receiving a flit, originating from a source node and destined for a target node;
accessing configuration data indicating whether to route the flit according to a first turn-restriction routing scheme or according to a second turn-restriction routing scheme different from the first turn-restriction routing scheme;
using the configuration data to determine whether to route the flit according to the first turn-restriction routing scheme or according to the second turn-restriction routing scheme; and
routing the flit according to the indicated turn-restriction routing scheme.

The configuration data may be specific to the source node and the target node, and the method may further comprise:
determining an identity of the source;
determining an identity of the target node; and
additionally using the determined identities of the source node and the target node when determining whether to route the flit according to the first turn-restriction routing scheme or according to the second turn-restriction routing scheme.

A non-transitory computer-readable medium may store computer-readable code for fabrication of any router and/or integrated-circuit apparatus disclosed herein.

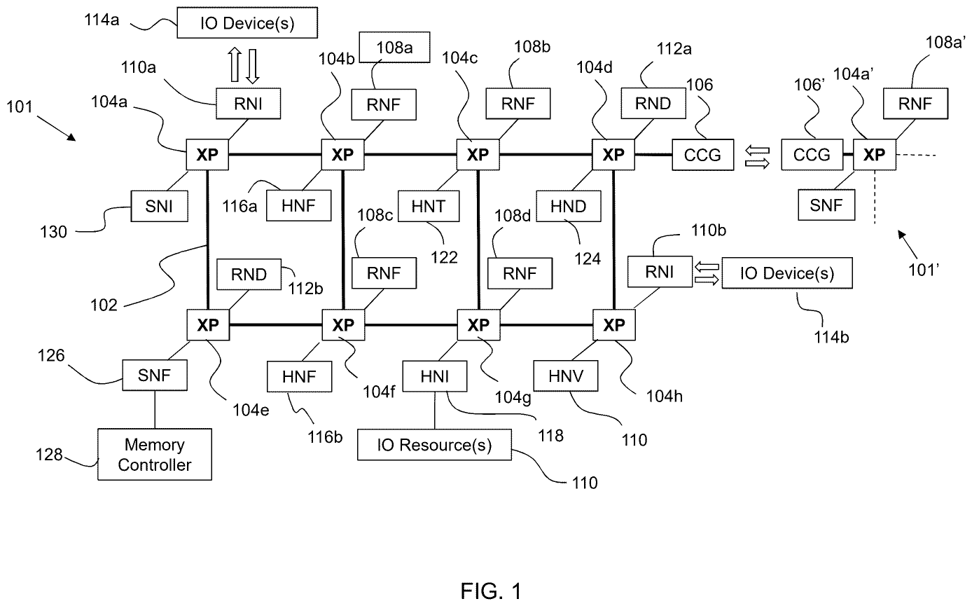

FIG. 1 shows part of an exemplary integrated-circuit data-processing system 101 (e.g. a system-on-chip). The system 101 includes an interconnect 102 comprising a rectangular array of set of routers 104, here labelled as cross-points (XP), coupled by physical channel (PC) links. The links provide horizontal (X-axis) and vertical (Y-axis) connections between adjacent XPs 104. The rectangular layout is a logical layout and is not necessarily reflected in the physical placement of the routers and other components on the integrated circuit, although it may be in some embodiments.

The integrated circuit data processing system 101 includes a plurality of nodes. The nodes are coupled together by the interconnect 102, thus forming a connection between the functional blocks which the nodes provide. The interconnect 102 provides signal connections between the nodes and may have various topologies. The interconnect 102 in FIG. 1 has a rectangular mesh topology, but in other variants it may be configured to form a mesh network, a ring network, a cross-bar network, or other network. The interconnect provides a number of cross-points (XPs) 104a-104h. Each cross-point 104a-104h provides one more device ports for coupling to nodes (e.g. to request nodes and home nodes as described below) and one or more network ports which couple to other respective cross-points. The device ports allows devices to upload data for transit over the interconnect 102 and to download data received by a device over the interconnect 102.

Each router 104 is a multi-channel router. In some examples, flits transmitted through the interconnect 4 are able to be sent on four channels provided by the interconnect 102—e.g. a Request Channel (REQ), a Response Channel (RESP), a Data Channel (DAT), and a Snoop Channel (SNP). Each of these (or only some, e.g. RESP and DAT) may be duplicated in order to provide separate channels for transmit (TX) and receive (RX). The REQ channel is used for sending read and write requests, cache maintenance requests, and Distributed Virtual Memory (DVM) requests. The RESP channel is used to send completion responses for various types of messages, ranging from write and cache management responses to data-less snoop responses and operation completion acknowledgments. The SNP channel issues snoops and sends DVM operations. The DAT channel is used to send write and read data, and snoop responses which include data.

Protocol messages are sent in the form of a flit. Flits are a packetized collection of control fields and identifiers that communicate a protocol message.

Some of the control fields sent in a flit include opcodes, memory attributes, address, data, and error responses. Each channel may use different flit control fields. For example, a flit to read or write on the Request channel uses an Address field, and a flit on the Data channel uses the Data and Byte Enable fields. The fields in a flit may be sent in parallel (i.e. not serialized over multiple packets).

There are three categories of node which may be present in the integrated circuit data processing system 101—these are Request Nodes (RNs), Home Nodes (HNs) and subordinate nodes (SNs). Each of these is described further below.

Chip-to-chip gateways (CCGs) can couple between a network on one chip or chiplet (i.e. one integrated circuit data processing system 101) and a similar network on another chip or chiplet (i.e. a second integrated circuit data processing system 101′). This enables formation of a network spanning multiple chips or c. Two example chip-to-chip gateways 106, 106′ belonging respectively to the first and second integrated circuit data processing systems 101, 101′ are shown in FIG. 1, connecting an XP 104d of the first integrated circuit data processing system 101 to an XP 104a′ of a second integrated circuit data processing system 101′. Only a small part of the second integrated circuit data processing system 101′ is shown.

In this example, CCG nodes 106, 106′ include both a request agent (RA), for issuing requests and receiving snoops, and a home agent (HA), for receiving requests and issuing snoops.

The role of request nodes is to generate transactions, such as read and write requests, in order to access and process data. These transactions are sent to Home Nodes (HNs).

There are several different varieties of request node, each of which is described by a corresponding term-a Fully Coherent Request Node (RNF), an input/output (I/O) Coherent Request Node (RNI), and an I/O Coherent RN with Distributed Virtual Memory (DVM) support (RND). A request node may be, for example, a central processing unit (CPU) core, a neural engine or other accelerator, or a Component Aggregation Layer that houses two or more CPU cores to be connected to one network port.

A Fully Coherent Request Node (RNF) contains coherent caches and will accept and respond to snoop messages for accessing or changing the coherency state of cached data. It will be understood that coherency refers to ensuring that all processors in the system see the same view of memory, meaning that changes to data held in the cache of one core are visible to the other cores, making it impossible for cores to see stale copies of data (the old data from before it was changed by the first core).

An I/O-Coherent Request Node (RNI) does not have a coherent cache, and cannot accept snoop messages. An I/O-Coherent Request Node with DVM support (RND) has the same functionality as an RNI and can also accept DVM messages. Example RNFs 108a-108d, 108a′, RNIs 110a, 110b, and RNDs 112a, 112b, are illustrated in the integrated circuit data processing system 101 of FIG. 1. As illustrated, the RNIs are connected to one or more IO devices 114a, 114b. Although not illustrated, it will be understood that the RNDs 112a, 112b, may also be connected to one or more IO devices.

Home Nodes (HNs) receive transactions from Request Nodes (RNs), and are responsible for ordering these requests, generating transactions to SNs (discussed below) and in some cases issuing snoops and handling DVM operations.

There are two main types of home node-fully coherent Home Nodes (HNFs), which order all requests to coherent memory and issue snoops to RN-Fs, and non-coherent Home Nodes (HNIs) which order requests that target an I/O subsystem. Both types act as a point of serialization.

The integrated circuit data processing system 101 includes a system level cache (SLC) which may reduce the number of accesses to memory and reduce the latency of data accesses. The system level cache may be distributed across a large set of home nodes in a network to share the cache capacity over all network nodes across multiple chips, in particular across the fully coherent home nodes (HNFs). The portion of a system level cache (SLC) present at a particular HNF may be referred to as a system cache group (SCG). A fully coherent home node (HNF) provides a point of coherency for a subset of system addresses and provides a cache for storing data associated with the addresses. Coherency may be provided by a snoop filter (SF) that tracks data copied to caches in the network caches. HNFs may thus comprise a system cache group (part of the system level cache) and a snoop filter. Thus, HNFs control coherency among data stored by the data processing system. Two example HNFs 116a, 116b are shown in FIG. 1, along with an example HNI 118, which is connected to one or more I/O resources 110.

There are further types of home node which are variations of the HNIs having additional functionality compared to an HNI-these include HNVs, HNTs, and HNDs. An HNV is an HNI which further includes a distributed virtual memory (DVM) node. An HNT is an HNI further including the functionality of both a DVM node and also a Debug Trace Controller (DTC). An HND is HNI further including the functionality of a DVM node, a DTC, and a configuration subordinate (which is a subordinate interface for configuration register space access). FIG. 1 shows an example HNV 110, HNT 122 and HND 124.

A distributed virtual memory (DVM) node, also referred to as a DN, controls its own respective DVM domain, such that each RNF sends its DVM requests to the DN in its own domain. DVM requests are messages that request a DVM operation in order to support maintenance of the virtual memory system. The DN propagates snoops and receives corresponding responses, based on the received DVM request.

Subordinate nodes (SNs) provide access to data sources and sinks, such as memory and peripheral devices. A memory or peripheral device may be located off-chip or on-chip (i.e. as part of the integrated circuit data processing system 101, or separate from it).

There are two types of subordinate node: fully coherent subordinate nodes (SNFs) which connect to memory devices that back the coherent memory space, and non-coherent subordinate nodes (SNIs) which connect to I/O peripherals or non-coherent memory. FIG. 1 shows an example SNF 126, connected to a memory controller 128, and an example SNI 130, which may be connected to non-coherent memory or an I/O peripheral.

Every component in the system is assigned a Unique Node ID. The system may then use a System Address Map (SAM) to convert physical addresses to Node IDs. These may be used by the XPs 104 for routing flits through the network. To be able to determine the target Node ID of outgoing requests, each RN and HN has a corresponding system address map.

It is highly desirable for mesh transport layers in mesh networks to implement predictable, deadlock free scheduling that decides the direction each flit on a physical channel should follow to transfer the flit from a source node to a target (i.e. destination) node. Complicated algorithms are undesirable as they can impose a significant processing burden on each mesh cross-point location (XP), which can affect mesh latency and timing closure to a specific frequency target.

To achieve a good balance between overhead of programming, storage and latency on each XP, an X-Y, Y-X, or two step X-Y-X and Y-X-Y policy may be used. The two steps approach typically needs the existence of an escape virtual channel (VC) in the same physical channel, or a way to move from one physical channel to another physical channel as a version of VC implementation. Since the requirement of an escape VC can be expensive, an X-Y or Y-X approach may be better suited to scalable and high performance meshes in which low latency is important.

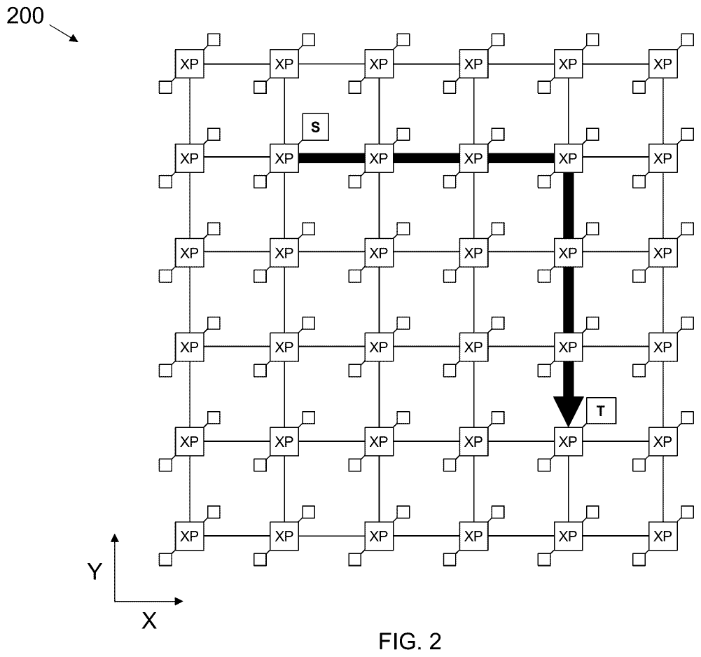

FIG. 2 illustrates X-Y routing within an interconnect 200 from a source node S, directly coupled to upload to a first cross-point, to a target node T, directly coupled to download from a second cross-point. A flit from node S first travels east three hops parallel to the X axis, before turning once and then travelling south three hops parallel to the Y axis. In general, when using X-Y routing, flits travel parallel to the X axis first, and then parallel to the Y axis, turning at most once.

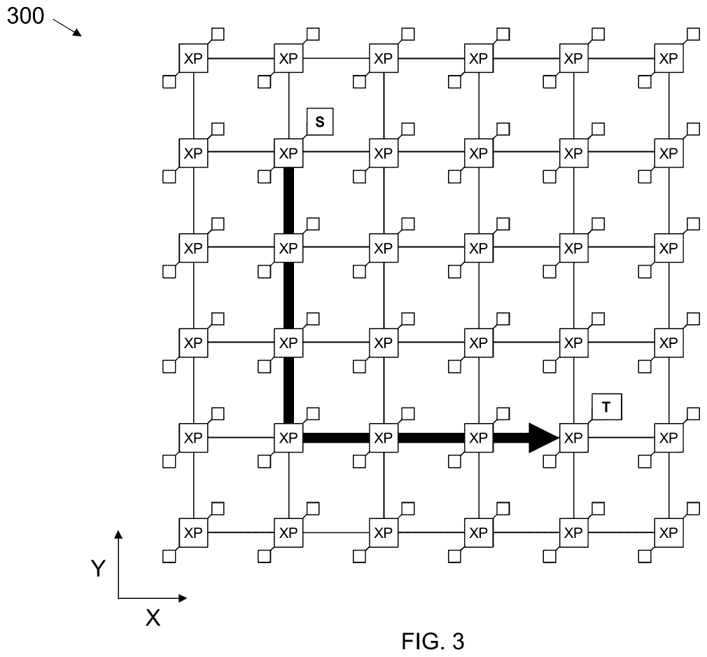

FIG. 3 illustrates Y-X routing within an interconnect 300 from a source node S, directly coupled to upload to a first cross-point, to a target node T, directly coupled to download from a second cross-point. A flit from node S first travels south three hops parallel to the Y axis, before turning once and then travelling east three hops parallel to the X-Y axis. In general, when using Y-X routing, flits travel parallel to the Y axis first, and then parallel to the X axis, turning at most once.

Static X-Y or Y-X routing is guaranteed to be deadlock free because it avoids any inherent cyclic dependency from a source to a destination and back to the same source.

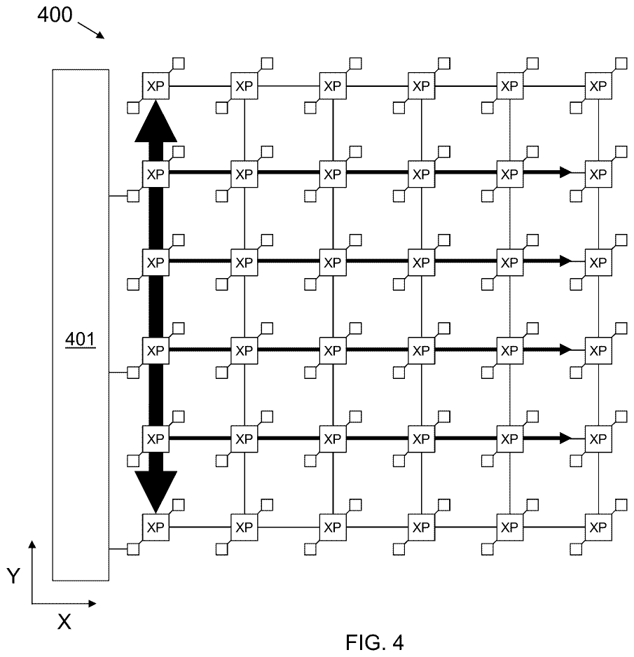

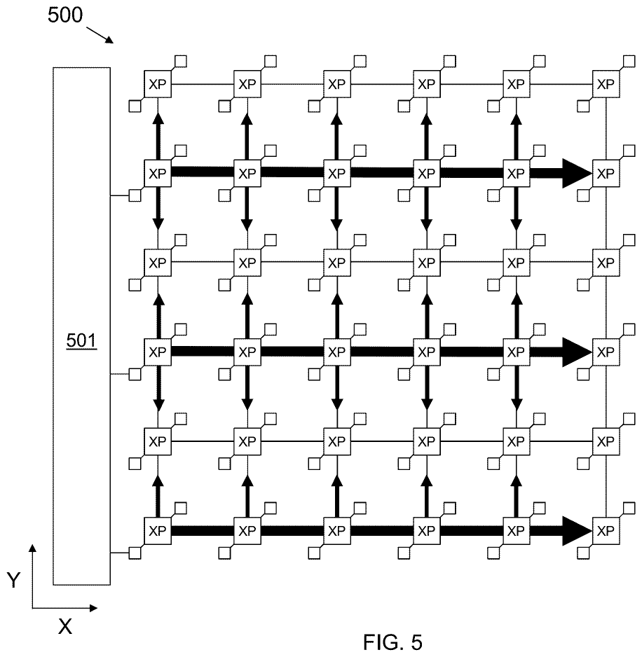

However, although applying a static X-Y or Y-X policy across a whole interconnect is attractive for its low design and implementation overheads, the inventors have recognised it can create undesirable problems. In particular, its performance can be highly sensitive to the location of high bandwidth devices and the paths used to transfer from such devices to other locations on the mesh. This is illustrated in FIGS. 4 and 5.

FIG. 4 shows an example interconnect 400 that is configured to implement Y-X routing and that has a high bandwidth memory 401 coupled to three XPs along its left (westerly) Y-axis edge. The Data flits returning from the memory 401 located on this left side of the mesh will first follow the Y dimension and move vertically on the leftmost column before switching to the appropriate row for their respective targets. This high level of sharing for the leftmost column (represented by a thick arrow in FIG. 4) creates a significant bottleneck. It may limit the cross-section bandwidth of the channel to one flit per cycle per link on the same column.

By contrast, FIG. 5 shows an example interconnect 500 that is configured to implement X-Y routing and that similarly has a high bandwidth memory 501 coupled to three XPs along its left (westerly) Y-axis edge. In this configuration, the Data flits returning from the memory 501 located on this left side of the mesh will first follow the X dimension, along any of three different rows, before moving vertically on the appropriate column for their respective targets. This approach distributes the read Data flits more evenly across the interconnect 500 without overloading the edge routers (XPs) on the edge immediately adjacent the high bandwidth memory 501.

However, the trade-offs are inverted when considering the Write paths, along which data moves from nodes such as HNFs or RNFs (as described above) to the memory 401 or 501. In this case, Y-X routing would be more favourable for these interconnects 400, 500. Some interconnects that are configured to use X-Y routing for read and write paths may nevertheless avoid this issue by affinitizing write data from HNFs to SNF ports that are located on the same horizontal rows as the HNFs, so that no vertical Y-axis movement is required at all, thereby not imposing a high load on the leftmost vertical edge.

If it were possible to design a network so that all high bandwidth devices are connected only to the vertical (or only to the horizontal) edges of the interconnect, then a static X-Y routing (or static Y-X routing) with suitable affinization for write paths, might be sufficient. However, in some networks, it may be desirable or necessary to put high bandwidth devices along both an X edge and a Y edge.

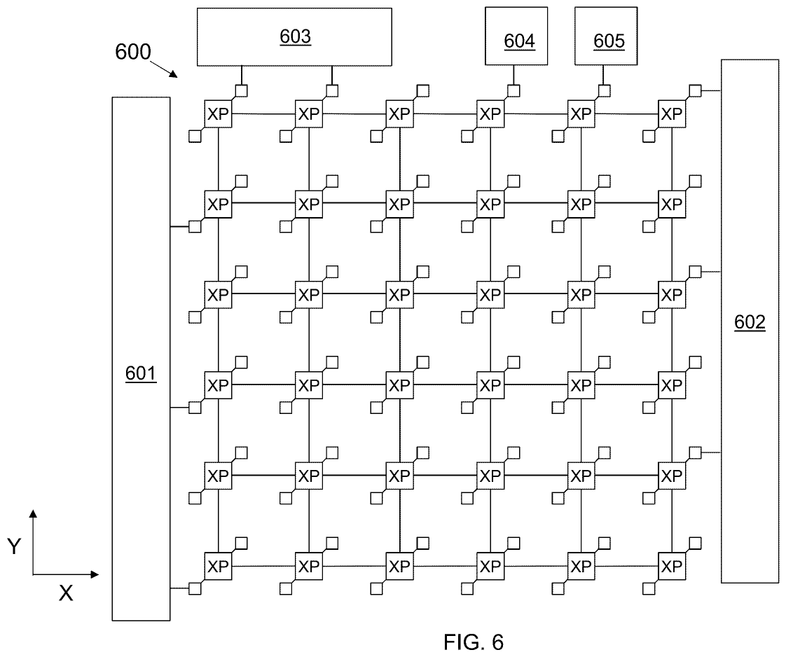

FIG. 6 shows an example interconnect 600 in which:
a first high-bandwidth memory 601 is coupled to three XPs along the left vertical edge
a second high-bandwidth memory 602 is coupled to three XPs along the right vertical edge
a LPDDR (Low-Power Double Data Rate) SDRAM (synchronous dynamic random-access memory) 603 is coupled to two XPs along the top horizontal edge
a PCIe bridge 604 is coupled to an XP on the top horizontal edge
a chip-to-chip gateway (CCG) 605 is coupled to the top horizontal edge

In the present disclosure, “high-bandwidth” may refer to memory having a maximum throughput of 8 TB/s or higher—e.g. in the interval 8-16 TB/s—but it could be lower in other examples. In some examples, LPDDR may slower than the high-bandwidth memory, e.g. having a maximum throughput below 8 TB/s, such as 1 TB/s.

These are just examples of potentially high bandwidth devices that could be coupled to the edges. There may also be one or more such devices coupled to XPs along the bottom horizontal edge in some examples.

If the interconnect 600 were to implement static X-Y or static Y-X routing for all flits, this would lead to congestion along the outside edges of the interconnect 600. However, in accordance with the disclosure, this example interconnect 600, along with any of the interconnects disclosed herein, supports simultaneously X-Y and Y-X routing on the same mesh, and without the need for an escape virtual channel (VC). The interconnect 600 can also be configured to do this in a way that does not create deadlocks.

The interconnect 600 may support multiple separate physical channels in order to meet bandwidth requirements. It may be configured to support a mixture of X-Y and Y-X paths based on the source and target for each data flow. In some embodiments, a router may also determine which routing scheme to use in dependence upon which channel a flit is on, while in other embodiments the same routing scheme may be used for all channels or for a subset of channels (e.g. for REQ, RSP, DAT, and SNP channels, but not the PUB channel).

Each XP is configured to determine whether to route a flit using X-Y or Y-X routing at least partly in dependence upon the source-target pair for the flit. This may be determined in accordance with data stored in a lookup table in each XP. In some embodiments, each XP may be configured to use X-Y routing by default, but to override this and use Y-X routing for flits containing identifiers of a source and a target that feature as a pair in a lookup table stored in each XP along a Y-X path from the source to the target.

The default X-Y routing of the interconnect 600 may be implemented by assigning numerical XID and YID identifiers to each XP that increase in the X and Y directions respectively. When routing a flit, each XP compares the XID and YID values of the target XP for the flit with the XP's own XID and YID XP to determine the routing direction.

If there is a mismatch between the target XP XID and the current XP XID, then the XP uses the following rule to decide the routing direction:
if target XP XID>current XP XID, then route eastwards
otherwise, route westwards

If the target XP XID and the current XP XID match, then the flit routing components are compared against the YID of the XP. If YIDs do not match, then the XP uses the following rule to decide the routing direction:
if target XP YID>current XP YID, then route northwards
otherwise, route southwards

If the target XP XID and YID match the current XP XID and YID, then the flit has reached the target XP. At this point, the flit is downloaded to the target device.

The interconnect 600 can be configured to override the default X-Y routing pattern and use Y-X routing instead for specific source-target pairs in the mesh. In this case, an XP uses the following rules:
if target XP YID>current XP YID, route northwards
if target XP YID<current XP YID, route southwards
if target XP YID==current XP YID and target XP XID>current XP XID, route eastwards
if target XP YID==current XP YID and target XP XID<current XP XID, route westwards
if target XP YID==current XP YID and target XP XID==current XP XID the flit has reached the target XP.

In some embodiments, the override may be configured to be specific to a particular channel, e.g. just to the Data channel. In some embodiments, up to sixteen source-target pairs can be configured in the interconnect 600 to route traffic using Y-X routing, i.e. against the default X-Y routing algorithm. This may be stored as configuration data in a memory of the IC apparatus. In some embodiments, a boot-programmable static Lookup Table (LUT) in each XP determines whether any given XP should route data using X-Y routing or Y-X routing. The selective use of Y-X routing by some or all routers along a path from a source to a target, can be used to avoid overloading the edge routers along edges to which high bandwidth devices are coupled, as explained herein. Applying all X-Y routing or all Y-X routing consistently within all the XPs along a path from a source to a target, rather than selectively, may aid in analysing the system to ensure it always provides deadlock free routing.

In the interconnect 600 of FIG. 6, the XPs are configured to use the default X-Y routing for flits originating from the high bandwidth memories 601, 602, which helps to push data inwards from the left and right vertical edges, to avoid overloading these edges. At the same time, the relevant XPs are configured to use the Y-X routing override for flits originating from the high bandwidth SDRAM 603, the PCIe bridge 604, and the chip-to-chip gateway (CCG) 605.

The selection of channel and routing algorithm to use is based on the source type and the target type. In some embodiments, IO (input-output) devices may be separated into a lower bandwidth class and a higher bandwidth class, and the home nodes (HNs) may be separated into home node groups assuming non-overlapping memory regions for a better distribution of bandwidth sources and targets. In addition the scheme may potentially be extended with the support of more physical channels (PCs) for a given channel. Devices may be enabled to upload/download from multiple physical channels based on the traffic class they have to serve. If a device has to separate traffic classes to avoid deadlocks then it may support the separation of PCs inside the device to avoid any congestion points and introducing deadlocks.

The selection of the physical channel (PC) may be supported on the upload XP port to/from a device, with the devices being agnostic to the number of PCs and traffic flows. Alternatively, this may be supported through the devices by introducing a separation of the channels and flows.

In some embodiments, XPs may support an override for a small number of paths (i.e. source-target pairs) within a same physical channel (PC) for diverting a smaller subset of traffic flows and avoiding the need of an extra PC. These may be limited to a few high bandwidth cases that include source-target pairs that do not create a cyclic dependency on resources and therefore are not expected to create a deadlock situation.

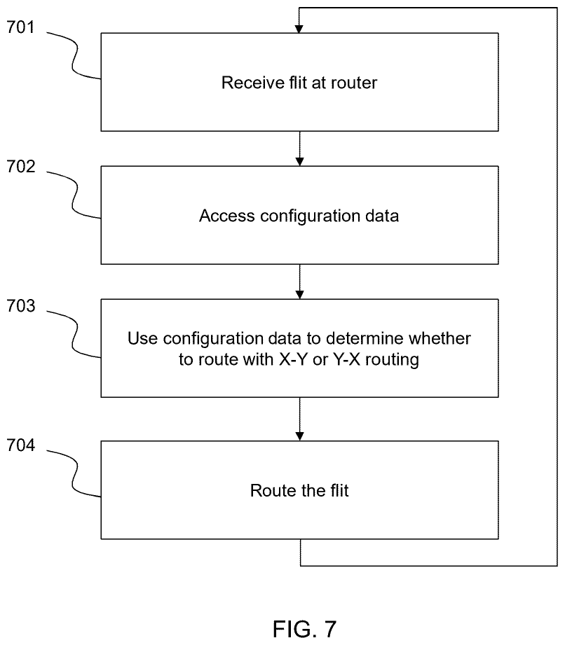

FIG. 7 is a flow chart of a method of routing a flit, performed by a router (XP) of an interconnect of an integrated-circuit apparatus. In a first step 701, the router receives a flit over a physical channel or from a device upload port. Next 702, the router accesses configuration data (e.g. a lookup table) stored on the router or elsewhere on the apparatus. Then 703, the router uses the configuration data to determine whether to route the flit using X-Y or Y-X routing. This may depend on factors including the source and/or target devices for the flit, and/or the channel the flit is on. The router then 704 routes the flit from a mesh port or device port in accordance with the determined routing.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the disclosure. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the disclosure. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

It will be appreciated by those skilled in the art that the disclosure has been illustrated by describing one or more specific embodiments thereof, but is not limited to these embodiments; many variations and modifications are possible within the spirit and scope of the disclosure.

We claim:

1. An integrated-circuit apparatus comprising:
a 2D or 3D interconnect comprising a plurality of routers distributed along at least an X axis and a Y axis, wherein the 2D or 3D interconnect comprises at least a first layer of routers logically coupled as a polygonal mesh of routers;
a first storage node or input-output node coupled to the interconnect along a Y-axis edge of the first layer, or a further layer, of routers of the interconnect; and
a second storage node or input-output node coupled to the interconnect along an X-axis edge of the first layer, or a further layer, of routers of the interconnect,
wherein at least a first router of the first layer of routers is configured to use X-Y routing when routing a flit originating from the first storage or input-output node and destined for a first target node coupled to the interconnect; and
wherein at least the first router or a second router of the first layer of routers is configured to use Y-X routing when routing a flit originating from the second storage or input-output node and destined for the first target node or a second target node coupled to the interconnect.

2. The integrated-circuit apparatus of claim 1, wherein the first router is configured to use Y-X routing when routing a flit originating from the second storage or input-output node and destined for the first or second target node.

3. The integrated-circuit apparatus of claim 1, wherein every router of the first layer on an X-Y path from the first storage or input-output node to the first target node is configured to use X-Y routing when routing a flit originating from the first storage or input-output node to the first target node along the X-Y path, and wherein every router of the first layer on a Y-X path from the first storage or input-output node to the first or second target node is configured to use Y-X routing when routing a flit originating from the second storage or input-output node and destined for the first or second target node along the Y-X path.

4. The integrated-circuit apparatus of claim 1, wherein every router of the first layer of routers is configured to use X-Y routing when routing a flit originating from the first storage or input-output node, and to use Y-X routing when routing a flit originating from the second storage or input-output node.

5. The integrated-circuit apparatus of claim 1, comprising:
a plurality of first storage or input-output nodes coupled to the interconnect along the aforesaid Y-axis edge; and
a plurality of second storage or input-output nodes coupled to the interconnect along the aforesaid X-axis edge, wherein:
at least the first router is configured to use X-Y routing when routing a flit originating from any of the first storage or input-output nodes; and
at least the first or second router is configured to use Y-X routing when routing a flit originating from any of the second storage or input-output nodes.

6. The integrated-circuit apparatus of claim 1, wherein:
at least the first router is configured to use Y-X routing when routing a flit originating from the first target node and destined for the first storage or input-output node; and
at least the first or second router is configured to use X-Y routing when routing a flit originating from the first or second target node and destined for the second storage or input-output node.

7. The integrated-circuit apparatus of claim 1, wherein, for every router of the first layer:
the router comprises a plurality of ports, each coupled to a further respective router of the plurality of routers;
the router is configured to route a flit, originating from a source node coupled to the interconnect and destined for a target node coupled to the interconnect, according to a first turn-restriction routing scheme when the router is operating in a first mode for the source node and the target node, and according to a second turn-restriction routing scheme, different from the first turn-restriction routing scheme, when the router is operating in a second mode for the source node and the target node; and
the router is configured to determine in which of the first and second modes to operate when routing the flit in dependence upon configuration data stored in a configuration memory of the integrated-circuit apparatus.

8. The integrated-circuit apparatus of claim 1, wherein the first or second storage node or input-output node is a memory or memory controller.

9. The integrated-circuit apparatus of claim 1, wherein the first or second storage node or input-output node is a peripheral or an interface to an interconnect, bus, chip or chiplet.

10. The integrated-circuit apparatus of claim 1, wherein, for at least one of the plurality of routers:
the router is configured to route data, originating from a source node coupled to the interconnect and destined for a target node coupled to the interconnect, according to X-Y routing when the router is operating in a first mode for the source node and target node, and according to Y-X routing when the router is operating in a second mode for the source node and target node; and
the router is configured to determine in which of the first and second modes to operate when routing the data in dependence upon configuration data.

11. The integrated-circuit apparatus of claim 10, comprising storage configured to store the configuration data, wherein the storage is writable by software executing on one or more processing devices of the integrated-circuit apparatus.

12. The integrated-circuit apparatus of claim 11, wherein the storage is writable only at a boot time of the integrated-circuit apparatus.

13. The integrated-circuit apparatus of claim 10, wherein the router is further configured, after receiving the data, to:
determine an identity of the source node;
determine an identity of the target node; and
determine in which of the first and second modes to operate when routing the data in further dependence upon the determined identities of the source node and target node.

14. The integrated-circuit apparatus of claim 10, comprising storage configured to store, for the router, separate respective configuration data for each of a plurality of combinations of source node and target node.

15. The integrated-circuit apparatus of claim 10, wherein, for every router of the plurality of routers:
the router is configured to route data, originating from a respective source node coupled to the interconnect and destined for a respective target node coupled to the interconnect, according to the X-Y routing when the router is operating in a first mode for the respective source node and respective target node, and according to Y-X routing, when the router is operating in a second mode for the respective source node and respective target node; and
the router is configured to determine in which of the first and second modes to operate when routing the data in dependence upon configuration data.

16. A method of routing a flit in an integrated-circuit apparatus, the integrated-circuit apparatus comprising:
an interconnect comprising a plurality of routers, wherein the plurality of routers are logically coupled as a polygonal mesh of routers;
a first storage or input-output node coupled to one or more of the routers along a Y-axis edge of the polygonal mesh of routers; and
a second storage or input-output node coupled to one or more routers along an X-axis edge of the polygonal mesh of routers, wherein the method comprises:
at least a first router of the plurality of routers using X-Y routing to route a flit originating from the first storage or input-output node and destined for a first target node coupled to the interconnect; and
at least the first router or a second router of the plurality of routers using Y-X routing to route a flit originating from the second storage or input-output node and destined for the first target node or a second target node coupled to the interconnect.

17. A non-transitory computer-readable medium storing computer-readable code for fabrication of an integrated-circuit apparatus according to claim 1.
